(19) United States
(12) Patent Application Publication
(10) Pub. No.: US 2005/0171827 A1
(43) Pub. Date: Aug. 4, 2005

(54) A METHOD FOR SUPPLY CHAIN COMPRESSION

(75) Inventors: Brian T. Denton, Winooski, VT (US); Robert J. Milne, Jericho, VT (US)

Correspondence Address: FREDERICK W. GIBB, III;MCGINN & GIBB, PLLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 10/707,978

(22) Filed: Jan. 29, 2004

(51) Int. Cl. G06F 17/60

(52) U.S. Cl. 705/8

(57) ABSTRACT

The invention provides a method and system comprising the identification of live stocking points and the filtering of files to include only live stocking points. The inventive stocking points reflect not only the part number but also the location within the bills of materials supply chain. The invention also provides a method and system for identifying live stocking points which efficiently handles circular supply chain flows such as those occurring due to: plants shipping to each other, planned rework, and part numbers being substituted for each other. In addition, the invention identifies live stocking points where only parts and locations that may be supplied are identified as live. The invention identifies the ability to substitute parts (“suppliability”) by examining component supply, inventory, capability to build, planned receipts, and capability of supplying the parts through substitution of other part(s).

### CROSS REFERENCE TO RELATED APPLICATIONS

The present application is related to pending U.S. patent application Ser. No. 10/______, filed concurrently herewith to Denton et al., entitled “METHOD FOR PURCHASE ORDER RESCHEDULING IN A LINEAR PROGRAM” having (IBM) Docket No. BUR92004009US1; U.S. patent application Ser. No. 10/______, filed concurrently herewith to Denton et al., entitled “A Method for Supply Chain Decomposition” having (IBM) Docket No. BUR920040007US1; U.S. patent application Ser. No. 10/______, filed concurrently herewith to Denton et al., entitled “A METHOD FOR OPTIMIZING FOUNDRY CAPACITY” having (IBM) Docket No. BUR920030195US1; U.S. patent application Ser. No. 10/______, filed concurrently herewith to Denton et al., entitled “METHOD FOR FAIR SHARING LIMITED RESOURCES BETWEEN MULTIPLE CUSTOMERS” having (IBM) Docket No. BUR920040010US1; U.S. patent application Ser. No. 10/______, filed concurrently herewith to Denton et al., entitled “A METHOD FOR CONSIDERING HIERARCHICAL PREEMPTIVE DEMAND PRIORITIES IN A SUPPLY CHAIN OPTIMIZATION MODEL” having (IBM) Docket No. BUR920030198US1; U.S. patent application Ser. No. 10/______, filed concurrently herewith to Denton et al., entitled “METHOD FOR SIMULTANEOUSLY CONSIDERING CUSTOMER COMMIT DATES AND CUSTOMER REQUEST DATES” having (IBM) Docket No. BUR920040008US1; and U.S. patent application Ser. No. 10/______, filed concurrently herewith to Denton et al., entitled “METHOD FOR IDENTIFYING PRODUCT ASSETS IN A SUPPLY CHAIN USED TO SATISFY MULTIPLE CUSTOMER DEMANDS” having Docket No. BUR820030346US1. The foregoing applications are assigned to the present assignee, and are all incorporated herein by reference.

### BACKGROUND OF INVENTION

1. Field of the Invention

The present invention relates to computer implementable decision support systems for determining active stocking points within a supply chain network. General methodologies within this field of study include advanced planning systems, optimization and heuristic based algorithms, constraint based programming, and simulation.

2. Description of the Related Art

A fundamental problem faced in all manufacturing industries is the allocation of material and capacity assets to meet end customer demand. Production lead times necessitate the advance planning of production starts, interplant shipments, and material substitutions throughout the supply chain so that these decisions are coordinated with the end customers'' demand for any of a wide range of finished products (typically on the order of thousands in semiconductor manufacturing). Such advance planning depends upon the availability of finite resources which include: finished goods inventory, work in process inventory (WIP) at various stages of the manufacturing system, and work-center capacity. Often, there are alternative possibilities for satisfying the demand. Products may be built at alternative locations and within a location there may be choices as to which materials or capacity to use to build the product. The product may be built directly or acquired through material substitution or purchase. When limited resources prevent the satisfaction of all demands, decisions need to be made as to which demand to satisfy and how to satisfy it. This resource allocation problem is often addressed through linear programming.

The below-referenced U.S. Patents disclose embodiments that were satisfactory for the purposes for which they were intended. The disclosures of both the below-referenced prior U.S. Patents, in their entireties, are hereby expressly incorporated by reference into the present invention for purposes including, but not limited to, indicating the background of the present invention and illustrating the state of the art: U.S. Pat. No. 5,971,585, “Best can do matching of assets with demand in microelectronics manufacturing,” Oct. 26, 1999; U.S. Pat. No. 5,943,484, “Advanced material requirements planning in microelectronics manufacturing,” Aug. 24, 1999; and Nemhauser, G. L. and Wolsey, L. A., 1999, Wiley, Integer and Combinatorial Optimization.

### SUMMARY OF INVENTION

The invention provides a method and system comprising the identification of live stocking points and the filtering of files to include only live stocking points. The inventive stocking points reflect not only the part number but also the location within the bills of materials supply chain. The invention also provides a method and system for identifying live stocking points which efficiently handles circular supply chain flows such as those occurring due to: plants shipping to each other, planned rework, and part numbers being substituted for each other. In addition, the invention identifies live stocking points where only parts and locations that may be supplied are identified as live. The invention identifies the ability to substitute parts (“suppliability”) by examining component supply, inventory, capability to build, planned receipts, and capability of supplying the parts through substitution of other part(s).

As shown below, the invention provides a method of allocating supply items from a supply chain network using a production planning system. After a customer order (comprising part numbers and a customer location) is input, a “demand item” is derived from the customer order. The demand item includes one of the part numbers and the customer location. The invention then uses this demand item and “explodes” the demand item through the supply chain network to identify a set of stocking points for the part number that can supply the part that the part number represents through shipping routes connected to the customer location. This exploding process also considers substitutes for the part number. This allows the invention to start with a set of stocking points that have demand associated with them and that can be shipped to the customer. Therefore, this process eliminates any stocking points that do not have an associated demand from being processed by the production planning system.

Then the invention determines which of these “demand associated” stocking points is still “live” and capable of supplying the part that the part number represents by performing a process of imploding the demand item through the set of supply stocking points. This process identifies the stocking points that have the current ability to supply the part number as active (e.g., live) stocking points, and identifies the stocking points that do not have the current ability to supply the part number as inactive (e.g., dead) stocking points. The imploding considers available inventory of the part number, capability to manufacture the part number, scheduled future delivery of the part number, etc. when determining if a stocking point is active or inactive.

The invention removes the inactive supple stocking points from the set of supply stocking points to allow only active stocking points to remain, which reduces the amount of data that is processed by the production planning system in the allocating process.

The exploding and imploding processes can be carried out recursively. More specifically, the invention derives additional demand items from the customer order. Each of the additional demand items has a different part number, but the same customer location. Then, the invention repeats the exploding and the imploding for the additional demand items derived from the customer order to produce a set of active stocking points. This process can also be recursively repeated for different customer orders. The stocking points that remain are all active and have associated demand. This allows the invention to very efficiently allocate the active stocking points to the customer orders using the production planning system to produce a material allocation plan.

### BRIEF DESCRIPTION OF DRAWINGS

FIG. 1: Flow chart providing an overview of the structure of a typical linear programming application.

FIG. 2: Flow chart providing an overview of the major steps of the invention

FIG. 3: Flow chart summarizing the steps involved in determining live stocking points

FIG. 4: Illustration of a network of stocking points with multiple levels of bill-of-material, binning, and substitution relationships.

FIG. 5: Illustration of a network of stocking points comprised of multiple locations, and shipping routes with loops.

### DETAILED DESCRIPTION

Detailed Description of Preferred Embodiment(s) of the Invention The current invention identifies stocking points that are active through an explosion of demand items through the bills of material, and utilizes two interweaving recursive functions to both explode and implode. The explosion element ensures that part/plants in the bills of material designated as live have (explicit or implicit) demand whereas the implosion element ensures that the live parts may obtain needed assets/material (from inventory on hand, from building at the plant, or shipping from another plant or sequence of plants, etc.) Active (live) part numbers and manufacturing plant location combinations are “marked” along the way to efficiently handle circular supply chain flows. In addition to the improved results over the prior art method, the current invention also represents a substantial improvement in run time (e.g., reduction of roughly 30 minutes for some production models when compared to a unidirectional method).

One advantage of this is that it results in substantially improved run times in advanced planning system solvers (e.g. linear programming solvers or heuristics). Typically, production planning departments use advanced planning systems to evaluate a range of scenarios over a fixed period of time (e.g. one week). During that time they will make several adjustments (e.g. data fixes, try to increase available capacity, modify demand etc.) to improve the overall plan. By the end of the planning cycle they must book a plan which will be used to set measurements for all of the individual business units in the supply chain. Being able to achieve faster turnaround time results in the ability to evaluate additional solutions during the planning cycle and hence may result in improved final plans.

To contrast the present invention, a conventional production planning linear program “LP” is shown below (such as that described in U.S. Pat. No. 5,971,585, which is incorporated herein by reference). This LP makes decisions including: production starts, material substitutions, and shipments planned to customers, between manufacturing and distribution locations, and from vendor suppliers. A LP is composed of an objective function that defines a measure of the quality of a given solution, and a set of linear constraints. The types of equations used in production planning models are well know to those practiced in the art and include:(1) Material Balance Constraints, which ensure conservation of material flow through the network of stocking points comprising the supply chain.

(2) Capacity Constraints, which ensure that the capacity available for manufacturing activities is not exceeded.

(3) Backorder Conservation Constraints, which balance the quantity of a given part backordered in a given planning period with the quantity backordered in the previous planning period and the net of new demand and new shipments.

(4) Sourcing Constraints, which define target ranges (minimum and maximum) of shipments that should be made from a particular manufacturing or vendor location in the supply chain.

A conventional LP formulation is provided below in the form familiar to those practiced in the art; i.e., definition of subscripts, definition of objective function coefficients, definition of constants, definition of decision variables, LP formulation or equations.

Definition of Subscripts

j—time period
m—material (part numbers)
a—plant location within the enterprise
n—material being substituted
z—group (which represents a family or collection of part numbers)
e—process (a method of purchasing or manufacturing a material at a plant)v—receiving plant location
k—demand center (i.e., customer location) (Note: the set of customer locations is mutually exclusive from the set of plant locations)
q—demand class which indicates relative priority
w—resource capacity which could be a machine, labor hour, or other constraint
u—represents a consumer location which refers to an internal plant, external demand center, or to a generic indicator meaning any plant/or demand center
   Definition of Objective Function Coefficients
PRCⱼₘₐₑ—cost of releasing one piece of part m during period j at plant a using process e
SUBCⱼₘₙₐ—substitution cost per piece of part number n which is being substituted by part number m during period j at plant a
TCⱼₘₐᵥ—transportation cost per piece of part number m leaving plant a during period j which are destined for plant v
INVCⱼₘₐ—inventory cost of holding one piece of part number m at the end of period j at a particular plant a
DMAXC_{jzau}—cost per piece of exceeding the maximum amount of shipments of group z parts from plant a to consuming location(s) u during period j
DMINC_{jzau}—cost per piece of falling short of the minimum amount of shipments specified for group z parts from plant a to consuming location(s) u during period j
BOC_{jmkq}—backorder cost of one piece of part m at the end of period j for class q demand at customer location k
   Definition of Constants
DEMAND_{jmkq}—demand requested during time period j for part number m at customer location k for demand class q
RECEIPTⱼₘₐ—quantity of projected wip and purchase order receipts for part number m expected to be received at plant a during time periodj
CAPACITY_{jaw}—Capacity resource w available at plant a during period j to support production starts
CAPREQ_{jmaew}—Capacity of resource w required for part
number m at plant a for process e during period j
QTYPERⱼₘₐₑₙ—quantity of component m needed per part number n during period j at plant a using process e
YIELDⱼₘₐₑ—output of part number m per piece released or started at plant a during time period j using process e
SUBQTYⱼₘₙₐ—quantity of part number m required to substitute for one piece of part number n at plant a during time period j
MAXPCT_{jzau}—maximum percentage of total shipments of group z (collection of parts) leaving supplier a during period j to support consumption at consuming location(s) u
MINPCT_{jzau}—minimum percentage of total shipments of group z (collection of parts) leaving supplier a during period j to support consumption at consuming location(s) u
CTⱼₘₐₑ—Cycle time. The number of periods between the release and completion of part m jobs for releases made using process e at plant a during time period j
TTₘₐᵥ—transport time for part number m from plant a to plant v
   Definition of LP Decision Variables
Iⱼₘₐ—Inventory at the end of period j for part number m at a particular plant a
Pⱼₘₐₑ—Production starts of part m during period j at plant a using process e
Lⱼₘₙₐ—Quantity of part number n which is being substituted by part number m during periodj at plant a
Tⱼₘₐᵥ—Internal shipments of part number m leaving plant a during period j which are destined for plant v
F_{jmakq}—Shipments of part number m leaving plant a during period j and satisfying class q demand at external customer k
B_{jmkq}—Back orders of part m at the end of period j for class q demand at customer location k
H_{Jzu} Total shipments of group z (z is a “collection” of parts) leaving suppliers during period j to support consumption at consuming location(s) u
S_{jzau} Amount by which total shipments of parts in z from plant a to consuming location(s) u during period j exceeds the maximum amount specified as desired in the sourcing rules
G_{jzau} Amount by which total shipments of group z parts from plant a to consuming location(s) u during period j falls short of the minimum amount specified as desired in the sourcing rules
   LP Equations or Formulation

The following minimizes the objective function subject to the constraints shown below.

Objective Function:

Minimize:

$${\sum }_{j} {\sum }_{m} {\sum }_{a} {\sum }_{e} {PRC}_{jmae} {P}_{jmae} + {\sum }_{j} {\sum }_{m} {\sum }_{n} {\sum }_{a} {SUBC}_{jmna} {L}_{jmna} + {\sum }_{j} {\sum }_{m} {\sum }_{a} {\sum }_{v} {TC}_{jmav} {T}_{jmav} + {\sum }_{j} {\sum }_{m} {\sum }_{a} {INVC}_{jma} {I}_{jma} + {\sum }_{j} {\sum }_{z} {\sum }_{a} {\sum }_{u} {DMAXC}_{jzau} {S}_{jzau} + {\sum }_{j} {\sum }_{z} {\sum }_{a} {\sum }_{u} {DMINC}_{jzau} {G}_{jzau} + {\sum }_{j} {\sum }_{m} {\sum }_{k} {\sum }_{q} {BOC}_{jmkq} {B}_{jmkq}$$

Subject to:

Sourcing Constraints:

$${H}_{jzu} = {\sum }_{{m}_{ɛ z}} {\sum }_{a} ( {T}_{jmau} + {\sum }_{q} {F}_{jmauq} ) {\sum }_{{m}_{ɛ z}} ( {T}_{jmau} + {\sum }_{q} {F}_{jmauq} ) - {S}_{jzau} \leq {MAXPCT}_{jzau} {H}_{jzu} {\sum }_{{m}_{ɛ z}} ( {T}_{jmau} + {\sum }_{q} {F}_{jmauq} ) + {G}_{jzau} \geq {MINPCT}_{jzau} {H}_{jzu}$$

Capacity Constraints:

$${\sum }_{m} {\sum }_{e} {CAPREQ}_{jmaew} {P}_{jmae} \leq {CAPACITY}_{jaw}$$

Backorder Constraints:

$${B}_{jmkq} = {B}_{( j - 1 ) mkq} + {DEMAND}_{jmkq} - {\sum }_{a} {F}_{jmakq}$$

Material Balance Constraints:

$${I}_{jma} = {I}_{( j - 1 ) ma} + {RECEIPT}_{jma} + {\sum }_{{xsi . t}_{x + {CT}_{xmae = j}}} {\sum }_{e} {YIELD}_{xmae} * {P}_{xmae} + {\sum }_{n} {L}_{jmna} + {\sum }_{{xs . t}_{x + {TT}_{mav = j}}} {\sum }_{v} {T}_{xmva} - {\sum }_{n} {SUBQTY}_{jmna} * {L}_{jmna} - {\sum }_{v} {T}_{jmav} - {\sum }_{k} {\sum }_{q} {F}_{jmakq} - {{\sum }_{{nst . m}_{is a component}}}_{of n} {\sum }_{e} {QTYPER}_{jmaen} {P}_{jnae}$$

Non-Negativity Constraints: all X_{i,j} . . . ≧0, where X is a generic decision variable and i, j etc. represent generic subscripts

In the supply chain linear programming model shown above, the material balance equations are a linear system of constraint equations that describe the flow of materials between stocking points throughout the supply chain (for purposes of this application, a stocking point is a position of a part represented by a part number in the bills-of-material at a particular plant in the enterprise). Those practiced in the art will recognize that the plant could represent a distribution center or regional warehouse in addition to the more obvious instance of a manufacturing plant. However, in conventional systems, production data contains huge amounts of irrelevant data (e.g. parts with no associated demand, components which can never be shipped because there is no established shipping route, obsolete inventory etc.). This extraneous (“dead”) data can clog production planning models resulting in poor solution run times and distracting irrelevant data in the output (e.g. reports with live parts interspersed with dead parts).

Conventional systems (e.g., U.S. Pat. No. 5,943,484) perform an explosion of demand through a bill of material file and eliminate those parts untouched by the explosion in order to reduce the data being processed through the system. However, such methods have serious deficiencies in manufacturing industries in which a number of plants conduct the same types of operations. Conventional systems are unable to recognize that parts may be live at some plants and dead at others, which results in a substantial number of inactive stocking points being included for consideration in the supply chain linear programming model. Furthermore, these methods are not efficient at identifying the circular supply chain flows that can occur in manufacturing industry due to: planned rework, plants shipping to each other, and parts being substituted for each other. Finally, the conventional one directional explosion does not account for parts being inactive at some plants due to the impossibility of being supplied with components.

This disclosure presents a method for compressing a mathematical structure to reduce the size, and hence, decrease input data quantity, and subsequently, runtime. The inventive approach, as it relates to supply chain optimization, minimizes the number of stocking points that need to be considered in the model. This method is used to project demand for finished goods down through the supply chain to collect all live PN/PLANT locations, i.e. stocking points, which need to be considered by the model. This is complicated because there are many criteria for determining if a stocking point must be considered, for example (a) does the stocking point have demand associated with it, (b) is the stocking point connected (via BOM relationship or shipping route) to another stocking point with associated demand, (c) is the stocking point related through material substitution rules, etc.

The quantity of data required for solving division level supply chain optimization problems requires that the algorithm used be fast. The invention is a fast recursive method for searching the system of stocking points and evaluating the ones that need to be considered in the model and the ones that can be omitted from the model. The invention allows for substantial generality in model input, including circular bill-of-material relationships, cyclic material substitutions, and cyclic shipping routes.

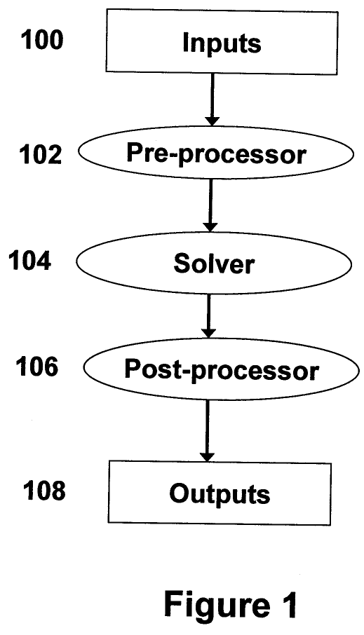

As shown in FIG. 1, a linear programming (LP) application includes the transformation of input files (block 100) into output files (block 108) through a pre-processor (block 102), solver (block 104), and post-processor (block 106). The pre-processor (block 102) transforms the raw input files into a form useable by the linear programming solver. Those practiced in the art will recognize that the input files could also be used with other types of advanced planning systems (e.g. one based on a heuristic or nonlinear program, rather than a linear program). The solver (block 104) determines an optimal raw output solution which is transformed by the post-processor (block 106) into a format acceptable for usage. The present invention is embedded in the pre-processor stage (block 102) and is used to compress the size of the supply chain considered by the solver (block 104). Although the embodiment is described in a context where the solver (block 104) is a linear program, those skilled in the art will recognize that any Advanced Planning System (APS) could be used as the solver including a heuristic based APS.

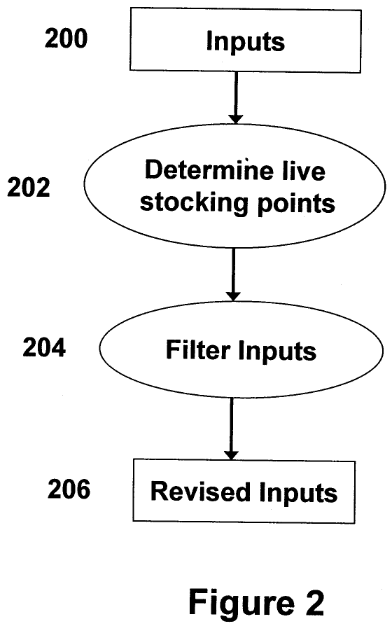

While block 10 still needs to convert the raw input files into a form useable by the solver, in addition to these responsibilities, in the present invention, block 102 will also filter out the input files so that only data for live stocking points remains present in the revised input files. These additional filtering steps incorporated by the invention are summarized in FIG. 2.

More specifically, in block 202, live stocking points are determined by exploding through the supply chain network to identify stocking points with associated customer demand. Only data associated with these live stocking points is relevant for purposes of solver calculation. Consequently, the invention filters out data containing dead (inactive) stocking points in block 204. The resulting revised input files (block 206) reflect the result of this filtering process. For input files (block 200) where part number and location are both present, the revised input files (block 206) will contain only those input records (block 200) where the part number and location combination are present in the live stocking points determined by block 202.

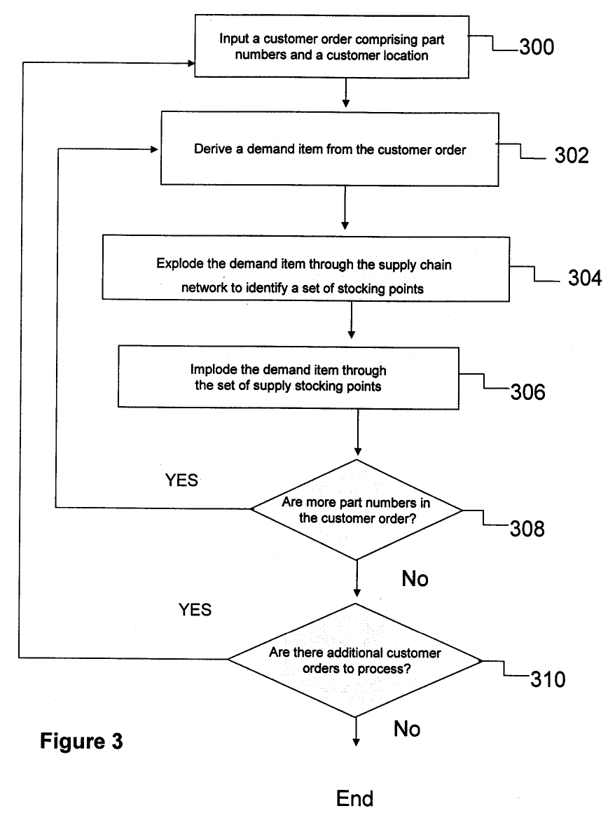

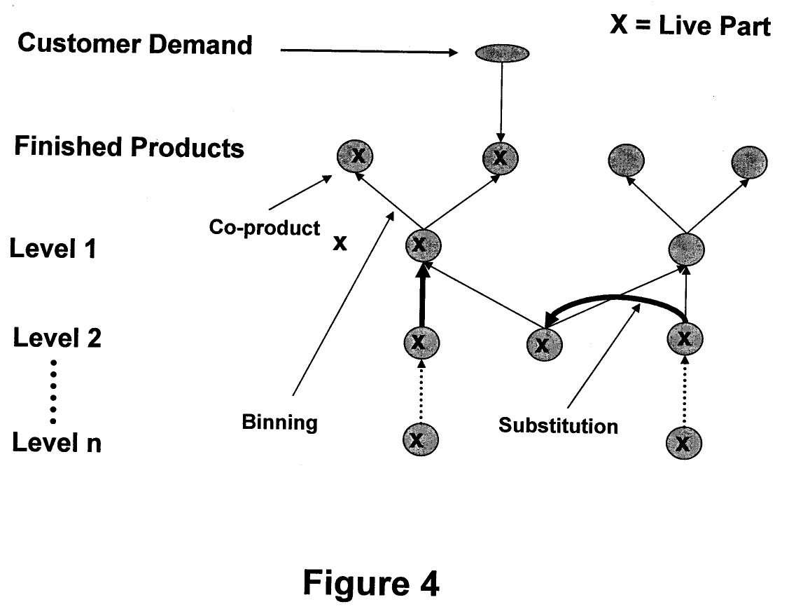

FIG. 3 summarizes the steps involved in the determination of live stocking points in block 202. Before processing, the stocking points as shown in FIG. 3 initialize all stocking points are marked as “dead” (i.e., inactive). The net result of the subsequent steps of FIG. 3 is to remove stocking points from the dead list and put them on the live list. In block 300 a customer order comprising part numbers and a customer location is input and, in item 302 a “demand item” is derived from the customer order. The demand item includes one of the part numbers and the customer location. The invention then uses this demand item and “explodes” the demand item through the supply chain network to identify a set of stocking points for the part number that have shipping routes connected to the customer location in item 304. This exploding process considers substitutes for the part number, as shown below in FIG. 4. This allows the invention to start with a set of stocking points that have demand associated with them and that can be shipped to the customer. Therefore, this process eliminates any stocking points that do not have an associated demand.

Then, the invention determines which of these “demand associated” stocking points is still “live” and capable of supplying the part that the part number represents by performing a process of imploding the demand item through the set of supply stocking points, in item 306. This process identifies the stocking points that have the current ability to supply the part number as active (e.g., live) stocking points, and identifies the stocking points that do not have the current ability to supply the part number as inactive (e.g., dead) stocking points. The imploding process considers available inventory of the part number, capability to manufacture the part number, scheduled future delivery of the part number, etc. when determining if a stocking point in active or inactive.

The exploding and imploding processes can be carried out simultaneously and recursively. In decision item 308, the invention checks to see if more part numbers are in the customer order. If so, the invention derives additional demand items from the customer order by returning processing to item 302. Each of the additional demand items that is processed in each recursive step has a different part number, but the same customer location. Then, the invention repeats the exploding and the imploding for the additional demand items derived from the customer order to produce a set of active stocking points for that customer order. This process can also be recursively repeated for different customer orders. More specifically, in decision item 310, the invention determines if there are additional customer orders to process. If so, processing proceeds back to item 300 to input the next customer order. Alternatively, multiple customer orders can be processed simultaneously in parallel.

In item 204, the invention filters out dead stocking points by removing the inactive supply stocking points from the set of supply stocking points to allow only active stocking points to remain, which reduces the amount of data that is processed by the production planning system in the allocating process.

After all part number in all customer orders are processed, all the stocking points that remain are active, have associated demand and can be shipped to the customer. This allows the invention to very efficiently allocate the active stocking points to the customer orders using the production planning system to produce a material allocation plan.

By way of example, FIG. 4 is a detailed illustration of how the invention utilizes binning, BOM, and substitution. The figure illustrates customer demand for a particular finished product. The finished product results form a (level 1) binning relationship that creates the specified finished product and an additional co-product. Due to the binning relationship the co-product must also be identified as live. The level 1 sub-assembly is further linked to level 2 through “n” assemblies, all of which are implied to be live due to the bill-of-material relationship. One of the level 2 sub-assemblies is further connected to another stocking point by way of a material substitution relation ship. Having identified the substitute part in the supply chain network the explosion algorithm must further search for parts connected to the substitute part in lower levels of the bill-of-material. However, higher level parts connected to the substitute part need not be marked as live since there is no bill-of-material relationship implied for higher levels.

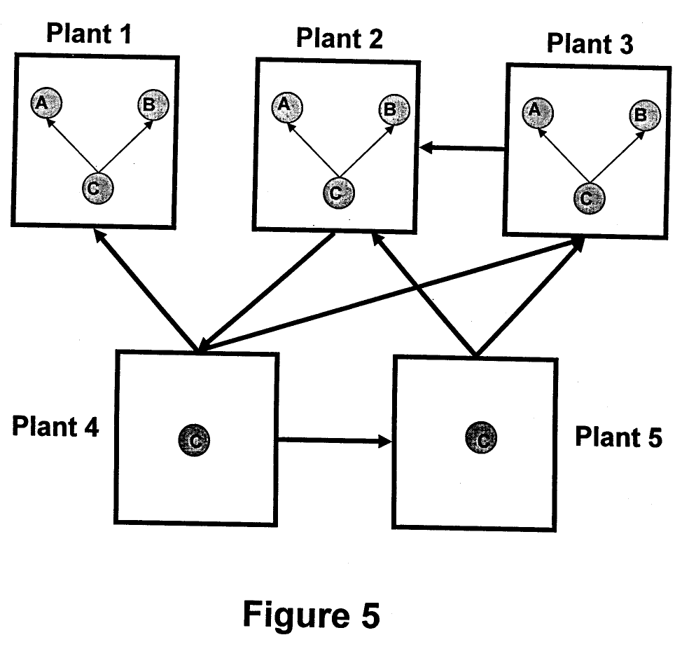

FIG. 5 is an illustration of how the invention uses shipping route relationships. In the figure there are several manufacturing plants described (it will be understood by one practiced in the art that the plants may represent supply vendor locations, customer locations, storage facilities, or transhipment points). In FIG. 5, plants 1-3 manufacture part numbers A and B from supply part number C. Similarly plants 4-5 manufacture and can ship part number C (plants 4-5 may be vendor locations or transhipment hubs). The interdependence of plants on part number C, either from a supply or demand perspective, introduces the need for shipping the part number between locations. The allowable shipping routes are denoted by arrows between locations. The figure illustrates the fact that shipping routes may be defined such that at least one circular shipping route can exist. For instance, based the allowable shipping routes part number C may be shipped from plant 4 to plant 5 to plant 3 to plant 2 and back to plant 4.

The ability to detect loops defined in a supply chain network is an important element of an effective search method. The present invention detects loops resulting from the definition of shipping routes, such as the example in FIG. 5, as well as loops defined by circular bill of material relationships, and material substitution relationships. (It will be understood to one practiced in the art that the invention could be extended to detect loops representing other types of supply chain relationships.) These relationships are detected by marking records representing shipping routes, bill-of-material relationships, and substitutions, when they identified within the search algorithm. Upon identification the record is marked with a numeric marker based on an order number representing the root customer order that initiated the search. For the remainder of the search each record is checked against the current customer order, and if a match is found then the record is ignored. The use of the customer order identifier allows the (necessary) reuse of records for further passes of the algorithm for other customer orders.

The following is a detailed pseudo code description of the algorithm used for determining live stocking points (FIG. 3). After these live stocking points are determined, the “dead” stocking points will be filtered out of the input files (block 204) thereby reducing overall system run time.

Definitions:

PN=part number
PLANT=manufacturing location
DMPLANT=a customer demand location which finished goods are shipped to
BLDOPT=indicates which manufacturing plant or vendor locations can build a PN
BIN =data on binning distributions for device parts
BOM=bill-of-material records
SUB=material substitution records specifying PN and sub PN (SUB_PN) at a given PLANT
INV=inventory of PN by PLANT location (stocking point) records
RECPT=receipt records for arrival of parts to specified stocking locations
SHIP=shipping records for allowable internal and external interplant shipments
LIVE_PARTS=list of PN/PLANTs that need to be considered in the supply chain model

FORCE_FLAG=yes/no flag indicating PN/PLANT should be added to LIVE_PARTS regardless whether stocking point is active (default is “no”)

//Main Program
main( ){
for(all unique PN/DMPLANT combinations in the demand
file){
for(each PLANT that can ship to DMPLANT according to
SHIP records){
if(add_to_list(PN/PLANT, FORCE_FLAG) == TRUE){
recursive_{—}
mark(PN/PLANT,BIN,BLD,BOM,SUB,INV,RECPT,PND,SHIP);
}
}
}
write live PN/PLANT combinations to LIVE_PARTS file;
}
//Recursive function for collecting live PN/PLANTs connected
via BIN and BOM records
int recursive_mark(PN,PLANT, etc.){
for(parts that are related to PN/PLANT through BIN
records){
if(BIN records not visited before){
mark BIN record as visited
set FORCE_FLAG=“yes”
add_to_list(PN/PLANT, FORCE_FLAG);
recursive_mark(PN,PLANT,etc.);
}
}
for(all unique BOM records with assembly PN matching
PN/PLANT){
for(assembly PLANT, and each PLANT that can ship component
PN to ASSM PLANT according to SHIP records){
if(add_to_list(COMP_PN/PLANT, FORCE_FLAG)=TRUE){
recursive_mark(COMP_PN,PLANT,etc.);
}
}
}
//end recursive_mark( );
//Recursive function for determining if PN/PLANT may be
built/supplied and collecting
//associated PN/PLANTs via shipping/substitution
int add_to_list(PN/PLANT, FORCE_FLAG){
//check if PN/PLANT qualifies for having assets via
BLDOPT, INV, or RECPT
if(PN/PLANT can be built in planning horizon according to
BLDOPT records){
if(BLD record not previously visited){
mark BLD record as visited
mark PN/PLANT as live
}
}
else if(there exists inventory of PN at PLANT according to
INV records){
if(INV record not previously visited){
mark INV record as visited
mark PN/PLANT as live
}
}
else if(there are receipts of PN at PLANT in planning horizon
according to RECPT records}
if(RECPT record not previously visited){
mark RECPT record as visited
mark PN/PLANT as live
}
}
for(all parts that can substitute for PN at PLANT according
to SUB records){
if(SUB record not previously visited){
if(add_to_list(SUB_PN/PLANT,FORCE_FLAG)==TRUE ){
recursive_mark(PN,PLANT,etc.);mark PN/PLANT as live;
}
mark SUB record as visited;
}
}
if(PN/PLANT marked as live){
for(all other plants (SHIP_PLANT) that can ship PN to
PLANT according to SHIP records){
if(if SHIP record not previously visited){
mark SHIP record as visisted;
if(add_to_list(PN/PLANT, FORCE_FLAG)==TRUE){
recursive_mark(PN,SHIP_PLANT,etc.)
mark PN/SHIP_PLANT as live;
}
}
}
}
if(PN/PLANT marked as live || FORCE_FLAG==“yes”){
add PN/PLANT to LIVE_PARTS
return TRUE;
}
else return FAIL;
}
//end_add_to_list( );

The present invention has been implemented on an IBM P690 server using the AIX operating system. The steps for implementing the present invention are preferably programmed in C/C++. It should be understood by those of ordinary skill in the art, however, that the present invention is not limited to the above implementation and is independent of the computer/system architecture. Accordingly, the present invention may equally be implemented on other computing platforms, programming languages and operating systems, and also may be hardwired into a circuit or other computational component.

Thus, as shown above, the invention provides a method of allocating supply items from a supply chain network using a production planning system. After a customer order (comprising part numbers and a customer location) is input, a “demand item” is derived from the customer order. The demand item includes one of the part numbers and the customer location. The invention then uses this demand item and “explodes” the demand item through the supply chain network to identify a set of stocking points for the part number that can supply the part that the part number represents through shipping routes connected to the customer location. This exploding process considers substitutes for the part number. This allows the invention to start with a set of stocking points that have demand associated with them and that can be shipped to the customer. Therefore, this process eliminates any stocking points that do not have an associated demand from being processed by the production planning system.

The invention also determines which of these “demand associated” stocking points is still “live” and capable of supplying the part that the part number represents by performing a process of imploding the demand item through the set of supply stocking points. This process identifies the stocking points that have the current ability to supply the part number as active (e.g., live) stocking points, and identifies the stocking points that do not have the current ability to supply the part number as inactive (e.g., dead) stocking points. The imploding considers available inventory of the part number, capability to manufacture the part number, scheduled future delivery of the part number, etc. when determining if a stocking point is active or inactive. It will be understood by those practiced in the art that the method could be practiced with additional criteria form which stocking points have ability to supply the part number.

The invention removes the inactive supply stocking points from the set of supply stocking points to allow only active stocking points to remain, which reduces the amount of data that is processed by the production planning system in the allocating process.

The exploding and imploding processes can be carried out recursively. More specifically, the invention derives additional demand items from the customer order. Each of the additional demand items has a different part number, but the same customer location. Then, the invention repeats the exploding and the imploding for the additional demand items derived from the customer order to produce a set of active stocking points. This process can also be recursively repeated for different customer orders. The stocking points that remain are all active and have associated demand. This allows the invention to very efficiently allocate the active stocking points to the customer orders using the production planning system to produce a material allocation plan.

The current invention identifies stocking points that are active through an explosion of demand items through the bills of material, and utilizes two interweaving recursive functions to both explode and implode. The explosion element ensures that part/plants in the bills of material designated as live have (explicit or implicit) demand whereas the implosion element ensures that the live parts may obtain needed assets/material (from inventory on hand, from building at the plant, or shipping from another plant or sequence of plants, etc.) Active (live) part numbers and manufacturing plant location combinations are “marked” along the way to efficiently handle circular supply chain flows. In addition to the improved results over the prior art method, the current invention also represents a substantial improvement in run time (e.g., reduction of roughly 30 min for some production models when compared to the unidirectional method).

While the invention has been described in terms of the preferred embodiments, those skilled in the art will recognize that the invention can be practiced with modification within the spirit and scope of the appended claims.

1. A method for filtering input data that is irrelevant for supply chain network planning purposes, said method comprising:
determining stocking points comprising a part number and a location by exploding through a supply chain network to identify stocking points that have associated demand; and
filtering input files to include only live stocking points.

2. The method of claim 1, wherein said filtering process comprises imploding said supply chain network to identify said live stocking points that have associated supply that may be used to satisfy said demand.

3. The method of claim 2, wherein said exploding and imploding are carried out recursively.

4. The method of claim 1, wherein said exploding process evaluates at least one shipping routes in the supply chain network.

5. The method of claim 2, wherein said imploding considers a stocking point to be live based on criteria comprising: available supply inventory, future availability of supply inventory, capability to manufacture said supply, and scheduled future delivery of said supply.

6. The method of claim 1, wherein said supply chain network comprises at least one bill of material, wherein said supply chain network comprises specified binning relationships, and wherein said supply chain network comprises multiple stocking locations and defined shipping routes.

7. The method of claim 1, wherein substitute stocking points are considered to be live if a corresponding stocking point is live, and co-product stocking points are considered to be live if an associated co-product stocking point live.

8. A method of allocating supply items from a supply chain network using a production planning system, said method comprising:
inputting a customer order comprising part numbers and a customer location;
deriving a demand item from said customer order, said demand item comprising a part number of said part numbers and said customer location;
exploding said demand item through said supply chain network to identify a set of stocking points for said part number that have shipping routes connected to said customer location;
imploding said demand item through said set of stocking points to:
identify ones of said stocking points that have the current ability to supply said part number as active stocking points; and
identify ones of said stocking points that do not have the current ability to supply said part number as inactive stocking points;
removing said inactive supply stocking points from said set of stocking points to allow only active stocking points to remain; and
allocating said active stocking points to said customer order using said production planning system to produce a material allocation plan.

9. The method in claim 8, further comprising repeating said method for different customer orders.

10. The method in claim 8, wherein said exploding process considers substitutes for said part number.

11. The method in claim 8, wherein said imploding considers available inventory of said part number, capability to manufacture said part number, and scheduled future delivery of said part number.

12. The method in claim 8, wherein said exploding and imploding processes are carried out recursively.

13. The method in claim 8, wherein said exploding and imploding processes reduce the amount of data that is processed by said production planning system in said allocating process.

14. The method in claim 8, further comprising:
deriving additional demand items from said customer order, each of said additional demand items comprising a different part number of said part numbers and said customer location; and
repeating said exploding and said imploding for said additional demand items derived from said customer order to produce a set of active stocking points.

15. A method of allocating supply items from a supply chain network using a production planning system, said method comprising:
inputting a customer order comprising part numbers and a customer location;
deriving a demand item from said customer order, said demand item comprising a part number of said part numbers and said customer location;
exploding said demand item through said supply chain network to identify a set of stocking points for said part number that have shipping routes connected to said customer location;
imploding said demand item through said set of stocking points to:
identify ones of said stocking points that have the current ability to supply said part number as active stocking points; and
identify ones of said stocking points that do not have the current ability to supply said part number as inactive stocking points;
removing said inactive supply stocking points from said set of stocking points to allow only active stocking points to remain;
deriving additional demand items from said customer order, each of said additional demand items comprising a different part number of said part numbers and said customer location;
repeating said exploding and said imploding for said additional demand items derived from said customer order to produce a set of active stocking points; and
allocating said active stocking points to said customer order using said production planning system to produce a material allocation plan.

16. The method in claim 15, further comprising repeating said method for different customer orders.

17. The method in claim 15, wherein said exploding process considers substitutes for said part number.

18. The method in claim 15, wherein said imploding considers available inventory of said part number, capability to manufacture said part number, and scheduled future delivery of said part number.

19. The method in claim 15, wherein said exploding and imploding processes are carried out recursively.

20. The method in claim 15, wherein said exploding and imploding processes reduce the amount of data that is processed by said production planning system in said allocating process.

21. A program storage device readable by machine, tangibly embodying a program of instructions executable by the machine to perform a method of allocating supply items from a supply chain network using a production planning system, said method comprising:
inputting a customer order comprising part numbers and a customer location;
deriving a demand item from said customer order, said demand item comprising a part number of said part numbers and said customer location;
exploding said demand item through said supply chain network to identify a set of stocking points for said part number that have shipping routes connected to said customer location;
imploding said demand item through said set of stocking points to:
identify ones of said stocking points that have the current ability to supply said part number as active stocking points; and
identify ones of said stocking points that do not have the current ability to supply said part number as inactive stocking points;
removing said inactive supply stocking points from said set of stocking points to allow only active stocking points to remain; and
allocating said active stocking points to said customer order using said production planning system to produce a material allocation plan.
